(19) United States
(12) Patent Application Publication
(10) Pub. No.: US 2014/0312279 A1
(43) Pub. Date: Oct. 23, 2014

(54) Play Composition Including Crosslinkable Binder

(71) Applicant: Abimael CORDOVA, La Mirada, CA (US)

(72) Inventor: Abimael CORDOVA, La Mirada, CA (US)

(73) Assignee: MATTEL, INC., El Segundo, CA (US)

(21) Appl. No.: 14/320,744

(22) Filed: Jul. 1, 2014

Related U.S. Application Data
(63) Continuation-in-part of application No. 14/070,796, filed on Nov. 4, 2013.
Application No. 14/070,796 is a continuation of application No. 12/957,721, filed on Dec. 1, 2010, now Pat. No. 8,603,236.

(51) Int. Cl. C08K 5/098; C08L 29/04; C08K 3/26; C08K 13/02; C09K 11/58; C08K 3/32

(52) U.S. Cl. CPC C08K 5/098; C09K 11/58; C08K 3/32; C08K 3/26; C08K 13/02; C08L 29/04; C08K 2003/324; C08K 2003/262
USPC 252/301.36; 106/205.01; 106/205.71; 106/205.2; 252/182.14; 523/105

(57) ABSTRACT

Water based play compositions include a crosslinkable network polymer and a crosslinking system effective to crosslink the polymer. The crosslinking system is a water-soluble salt complex including a primary crosslinking agent, a secondary crosslinking agent, and a tertiary crosslinking agent. The crosslinking system contains zirconium and/or titanium compounds that are effective in crosslinking network polymers including polyvinyl alcohol (to form moldable dough compositions) and guar gum (to form hydrogels).

### CROSS REFERENCE TO RELATED APPLICATION

This application is a continuation-in-part of U.S. patent application Ser. No. 14/070,796, entitled “Play Composition Including Crosslinkable Binder,” filed Nov. 4, 2013, which is a continuation of U.S. patent application Ser. No. 12/957,721, entitled “Play Composition Including Crosslinkable Binder,” filed Dec. 1, 2010, the disclosures of which are incorporated herein by reference in their entireties.

### FIELD OF THE INVENTION

The present invention is directed toward play compositions formed of a binder and a cross-linking system including a water soluble salt complex.

### BACKGROUND OF THE INVENTION

Through the years, play compositions of different types have been provided by practitioners in the toy arts to amuse children and adults and to aid in the development of manual skills and dexterity, as well as creativity. While the variety of such play material compositions is numerous, all generally involve the use of free-forming or malleable materials that are manipulated and shaped by the user. Certain materials have been provided which are moldable and tend to retain their shapes (e.g., modeling clay), while others are looser and more free-flowing. Others still are gels having fluid-like flow characteristics.

Regardless of the type of play compositions used, it is essential that such materials be safe for young children. Safety requirements generally mandate that play material compositions be nonirritating to the skin and eyes, and be nontoxic if ingested. Additional requirements have been expected of these materials to avoid damage to clothing, upholstery fabric, or carpeting. Conventional play compositions such as those described above typically include boron compounds such as sodium tetraborate that function as a crosslinking agent. Boron compounds, while an effective crosslinking agent, have recently come under scrutiny by some as a potential irritant when present in high concentrations. Lowering the amount of boron compounds in a composition, however, deteriorates the polymer network the compounds are intended to create. Thus, it is desirable to formulate a crosslinking system that minimizes the amount of boron compounds (and, in particular, sodium tetraborate) while providing the crosslinking properties necessary to form usable play compositions.

### SUMMARY OF THE INVENTION

The present invention is directed toward water-based play compositions including a crosslinkable network polymer and a crosslinking system effective to crosslink the polymer. The crosslinking system is a water-soluble salt complex including a primary crosslinking agent, a secondary crosslinking agent, and a tertiary crosslinking agent. The primary crosslinking agent is a water-soluble alkali metal salt or a phosphoric acid sodium salt. The secondary crosslinking agent is a water-soluble alkali metal salt. The tertiary crosslinking agent comprises a water soluble-boric acid salt or one or more of a zirconium compound and a titanium compound. When utilizing a water soluble-boric acid salt, the crosslinking system contains a diminished amount of boron compounds while remaining effective in crosslinking network polymers including polyvinyl alcohol (to form moldable dough compositions) and guar gum (to form hydrogels). When utilizing a zirconium and/or titanium compound, the crosslinking system is also effective in crosslinking network polymers including polyvinyl alcohol (to form moldable dough compositions) and guar gum (to form hydrogels).

### DESCRIPTION OF THE PREFERRED EMBODIMENTS

The crosslinking system of the present invention generates crosslinks between molecules of a crosslinkable polymer to form a polymer network. The crosslinking system is a water-soluble salt complex including a primary crosslinking agent, a secondary crosslinking agent, and a tertiary crosslinking agent (also called a gelling agent or chelating agent).

In some embodiments, the primary crosslinking agent generates the largest crosslink density in the network polymer (i.e., the binder of the play composition) compared to the other agents within the crosslinking system. That is, the primary crosslinking agent generates the largest number of crosslinks per unit volume in the network polymer.

In an embodiment of the present invention, the primary crosslinking agent generates at least about 45% of the crosslinks within the network polymer. By way of example, the primary crosslinking agent generates about 55% of the crosslinks within the network polymer. The primary crosslinking agent is effective in alkaline environments (e.g., environments having pH ranges of 8.5-10). In an embodiment of the present invention, the primary crosslinking agent is a water-soluble alkali metal bicarbonate. By way of example, the primary crosslinking agent is potassium bicarbonate (KHCO₃). Alternative compounds may include magnesium bicarbonate, sodium bicarbonate, derivatives thereof and combinations thereof. In another embodiment of the present invention, the primary crosslinking agent is a salt of a phosphoric acid such as disodium hydrogen phosphate (Na₂HPO₄, also known as sodium phosphate dibasic), magnesium phosphate dibasic, potassium phosphate dibasic, derivatives thereof, and combinations thereof.

In certain example embodiments, one or both of the secondary and tertiary crosslinking agents in the crosslinking system of the present invention generates a lower crosslinking density than that of the primary crosslinking agent (i.e., each generates a lower number of crosslinks per unit volume in the polymer network).

In an embodiment, the secondary crosslinking agent generates no more than about 30% of the crosslinks within the network polymer. By way of example, the secondary crosslinking agent generates about 25% of the crosslinks in the network polymer. In an embodiment, the secondary crosslinking agent is a water-soluble alkali metal carbonate. By way of example, the secondary crosslinking agent is a sodium carbonate (Na₂CO₃), sodium sulfate, potassium sulfate, potassium carbonate, magnesium carbonate, derivatives thereof and combinations thereof. The secondary crosslinking agent is selected to be effective within a slightly acidic to slightly alkaline environment (e.g., environments having pH ranges of 5.1-8.4)

The tertiary crosslinking agent may be any suitable one or more compounds that generate a desired crosslink density in relation to the primary and secondary crosslinking agents. For example, the tertiary crosslinking agent may generate a lower crosslink density than both the primary and secondary crosslinking agents. The tertiary crosslinking agent may generate no more than 25% of the crosslinks within the network polymer. By way of example the tertiary crosslinking agent generates about 15%-20% of the crosslinks within the network polymer. The tertiary crosslinking agent can further be selected to be effective in acidic to alkaline environments (e.g. environments having a pH of 5.1-9.5). /

In further embodiments, the amounts and/or types of primary, secondary and tertiary crosslinking agents provided in the gel composition can be selected such that any of the crosslinking agents generates about the same or even more crosslinks in relation to any of the other crosslinking agents. For example, the secondary crosslinking agent provided in the gel composition may generate more crosslinks than either or both the primary and tertiary crosslinking agents. In another example, the tertiary crosslinking agent provided in the gel composition may generate more crosslinks than either or both the primary and tertiary crosslinking agents.

In an embodiment of the present invention, the tertiary crosslinking agent is a boron compound such as salts of boric acid. By way of example, the tertiary crosslinking agent comprises sodium tetraborate (Na₂B₄O₇).

In another embodiment of the present invention, the tertiary crosslinking agent is one or more of a zirconium compound and a titanium compound. By way of example, the tertiary crosslinking agent comprises zirconium lactate (C₁₂H₂₀O₁₂Zr). By way of another example, the tertiary crosslinking agent comprises a combination of titanium (e.g., titanium tetrachloride, TiCl₄) with a polyol (e.g., a glycol).

In still a further embodiment of the present invention, the tertiary crosslinking agent is a combination of any two or more of a boron compound, a zirconium compound and a titanium compound.

The agents of the crosslinking system are present in amounts effective to generate the desired level of crosslinking of the binder forming the play composition. In an example embodiment of the present invention, the primary crosslinking agent is present in the largest amount within the crosslinking system, the secondary crosslinking agent is present in an amount less than the primary crosslinking agent but greater than the amount of the tertiary crosslinking agent. However, in other embodiments, any of the primary, secondary and tertiary crosslinking agents can be present in the largest amount within the crosslinking system. For example, in the embodiments described herein in relation to Examples 2 and 3, the tertiary crosslinking agent is provided in the largest amount in relation to each of the primary and secondary crosslinking agents.

In an example embodiment, when the primary crosslinking agent is sodium phosphate dibasic and the tertiary crosslinking agent is a boron compound, the primary crosslinking agent is added to the play composition in an amount of about 0.10 wt % to about 1.5 wt %; the secondary crosslinking agent is added to the play composition in an amount of from about 0.01 wt % to about 0.50 wt %; and the tertiary crosslinking agent is added to the play composition in an amount of from about 0.005 wt % to about 0.50 wt % (based on the total weight of the play composition). By way of further example, when the primary crosslinking agent is potassium bicarbonate and the tertiary crosslinking agent is a boron compound, the primary crosslinking agent is added to the play composition in an amount of about 0.50 wt % to about 3 wt %, the secondary crosslinking agent is added to the play composition in an amount of from about 0.10 wt % to about 0.80 wt %; and the tertiary crosslinking agent is added to the play composition in an amount of from about 0.005 wt % to about 0.50 wt % (based on the total weight of the play composition).

The above formulation provides a crosslinking system that is effective to crosslink the binder throughout various pH levels. For an example system that utilizes boron compounds for the tertiary crosslinking agent, the crosslinking system is highly effective at creating a desired polymer network while including a substantially lower amount of boron compounds than conventional compositions. By way of example, the amount of borate compound utilized to crosslink the play composition is less than about 0.50% by weight play composition. Preferably, the amount of borate compound utilized is less than about 0.10% by weight play composition.

In another example, when the primary crosslinking agent is sodium phosphate dibasic and the tertiary crosslinking agent is a zirconium or a titanium compound, the primary crosslinking agent is added to the play composition in an amount of about 0.10 wt % to about 1.5 wt %; the secondary crosslinking agent is added to the play composition in an amount of from about 0.01 wt % to about 1.50 wt %; and the tertiary crosslinking agent is added to the play composition in an amount of from about 0.5 wt % to about 4.0 wt % (based on the total weight of the play composition). In this example embodiment in which the tertiary crosslinking agent comprises a zirconium or titanium compound, the tertiary crosslinking agent (e.g., zirconium lactate or a titanium-glycol combination) can be present in the greatest amount in relation to the primary and secondary crosslinking agents.

As noted above, the crosslinking system in accordance with the present invention is utilized to form play compositions having desired properties. In an embodiment, the crosslinking system is utilized to form gel compositions having cold flow characteristics. For example, the crosslinking system may be utilized in the formation of a flowable gel composition including a polymer or colloidal network that is expanded throughout its whole volume by a fluid. Specifically, the play composition is a hydrogel having distinct flow properties—the gel is amorphous, possesses a high flow rate, and can be recombined after tearing (i.e., the gel is self-healing).

The gel composition includes water and a polymer binder (i.e., a network polymer) crosslinked with the above-described crosslinking system. While tap water may be utilized, deionized water is preferred to minimize the occurrence of any impurities that may interfere with crosslinking. In an embodiment of the present invention, water is present within the gel composition in an amount of about 75 wt % or more and, in particular, about 90 wt % or more. By way of example, the water is present in an amount of at least about 90% by weight gel composition but can even be about 95% by weight gel composition. Water content below the lower threshold leads to incomplete hydrolysis of the binder (resulting in partial cross-linking), while water in excess of 95% results in excess water, which weakens the polymer network.

In an embodiment, the polymer binder is a network forming guar polymer such as guar gum (C₂₁H₃₆O₁₅) and guar derivatives. Guar derivatives include hydroxypropyl guar (HPG), carboxymethyl guar (CMG), carboxymethyl hydroxypropyl guar (CMHPG), and carboxymethyl cellulose. The guar polymers may be nonionic, anionic, or cationic. In an embodiment of the present invention, the polymer binder is present within the gel composition in an amount of about 0.50 wt % to about 3 wt %. By way of example, the amount of polymer binder present is about 1% by weight gel composition.

The crosslinking system includes a combination of agents present in an amount effective to achieve the gel point of the polymer network.

In an embodiment of the present invention in which the tertiary crosslinking agent is a boron compound, the crosslinking system is present within the gel composition in an amount of about 0.10 wt % to about 3.5 wt % or greater. In an embodiment of the present invention, the primary crosslinking agent is disodium hydrogen phosphate, the secondary crosslinking agent is sodium carbonate, and the tertiary crosslinking agent is sodium tetraborate. In an embodiment of the present invention, the primary crosslinking agent is present within the gel composition in an amount of about 0.10 wt % to about 1.50 wt %, the secondary crosslinking agent is present in an amount of about 0.01 wt % to about 0.50 wt %, and the tertiary crosslinking agent is present in an amount of about 0.005 wt % to about 0.5 wt %. By way of example, the amount of primary crosslinking agent is about 0.40% by weight gel composition, the amount of secondary crosslinking agent is about 0.15% by weight gel composition, and the amount of tertiary crosslinking agent is about 0.05% by weight gel composition. In an embodiment of the present invention, the amount of borate compound present in the gel composition is less than about 0.50 wt %, and preferably less than about 0.10 wt %.

In embodiments in which a zirconium or a titanium compound is used, the amount of tertiary crosslinking agent present within the gel composition is 0.1 wt % to 4.0 wt % such that the amount of tertiary crosslinking agent within the gel composition can be greater than either or both the primary and secondary crosslinking agents.

The gel composition may include one or more additives. By way of example, the gel composition includes a preservative in an amount of from about 0.50 wt % to about 1.50 wt %. The preservative may include, but is not limited to, phenoxyethanol, methylpropanediol, methylparaben, ethylparaben, butlyparaben, propylparaben, isobutylparaben, hydroxamic acid, and combinations of two or more of the above. By way of specific example, the composition may include about 1 wt % Phenonip® XB (a preservative blend available from Clariant International AG, Muttenz, Switzerland). In another specific example, the composition may include about 1 wt % Phenostat™ (a preservative blend available from Inolex Chemical Company, Pennsylvania). Many other commercially available preservatives well known to those skilled in the art may also be utilized.

The gel composition of the present invention may also include one or more humectants. Humectants are hygroscopic substances that capture water via absorption or adsorption. Thus, humectants not only aid in the prevention of water loss from the composition, but will capture additional water from the environment. In an embodiment of the present invention, the humectant is present within the gel composition in an amount of about 1 wt % to about 3 wt %. By way of example, the amount of humectant is about 1.5% to about 2% by weight gel composition. In an embodiment of the present invention, the humectant is glycerin, diols such as polyethylene glycol, propylene glycol, ethylene glycol, derivatives thereof and mixtures thereof. Humectants such as glycerin and polyethylene glycol also function as plasticizers (promoting elongation/stretch of the composition) and/or dispersants (improve the separation of particles and to prevent settling or clumping).

The gel composition of the present invention may further include a colorant (e.g., a pigment or dye) to enhance its entertainment or play effect. Typical colorants include FD&C Powder Series colorants (available from Sensient Technologies Corporation, Milwaukee, Wis.), as well as the DayGlo® T-Series colorants (available from DayGlo Color Corporation, Cleveland, Ohio). In addition, phosphorescent color additives, such as zinc sulfide (ZnS) (e.g., ZnS available under the trade name Phosphorescent Pigment 6SSU from United Mineral and Chemical Corporation, New Jersey) can be added to provide a phosphorescent color effect to the gel composition. The colorant may be present within the gel composition in an amount of about 0.50 wt % to about 2.50 wt %. By way of example, the amount of colorant present is about 1% by weight gel composition. The amount of phosphorescent color additive present in the gel composition can be from about 1 wt % to about 4 wt %, with an example amount being about 3 wt %.

The above described gel composition possesses several unique properties. For example, certain gel compositions formed as described herein can have a specific gravity of approximately 0.8-1.4, a density of approximately 0.8-1.4 g/cm³; and a viscosity of less than about 1000 cP (e.g., about 500 cP to about 1000 cP). The gel composition, moreover, possesses a pH value of 7 or above. By way of example, the gel composition may possess a pH value of about 8.3 or about 9.2.

In an embodiment of the present invention, the process to form the gel composition includes the formation and subsequent combining of separate binder and crosslinking system formulations. In a first mixing vessel (e.g., a mixing vessel fitted with a sweep and a homogenizer) a binder formulation or phase is created. A predetermined amount of water at room temperature (e.g., deionized water constituting about 90 wt % of the final composition) is added to the first vessel, along with additives (e.g., preservatives or humectants), and stirring occurs for a predetermined period of time (e.g., about 5-15 minutes). Colorant and/or phosphorescent color additive may be added, followed by the addition of the binder. The resulting solution is mixed for a predetermined period of time to incorporate the binder (e.g., about 3-10 minutes). The pH can further be adjusted as needed (e.g., adding sodium hydroxide and/or triethanolamine to adjust the pH level above 7). The solution can optionally be heated to a predetermined temperature range (e.g., 90° F. to 130° F.), and the heated solution is mixed for a predetermined amount of time (e.g., 3-10 minutes).

In a second mixing vessel, the crosslinking system formulation or phase is formed. The primary crosslinking agent, the secondary crosslinking agent, and the tertiary crosslinking agent are added to the second mixing vessel. The remaining water is added and the resulting solution is heated to a predetermined temperature range (e.g., 130° F. to 190° F.). Alternatively, the water may be heated to the predetermined temperature range before its addition to the second mixing vessel. The solution is then maintained at the predetermined temperature to permit dissolution of the crosslinking system components into the water. Once the components of the crosslinking system have dissolved, the crosslinking formulation is added to the first mixing vessel containing the binder formulation. The combined formulations are mixed, forming the gel composition.

A formulation for a gel composition in accordance with embodiments of the present invention is provided in each example below with reference to the tables associated with each example.

### EXAMPLE 1

TABLE I

| Ingredient | Approximate Weight % |
|---|---|
| Deionized Water | 94 |
| Binder | 1 |
| Crosslinking System | |
| Sodium Phosphate (dibasic) | 0.40 |
| Sodium Carbonate (anhydrous) | 0.15 |
| Sodium Tetraborate (anhydrous) | 0.05 |
| Additives (humectant, preservative, colorant) | 4 |

About 90 wt % water, humectant (glycerin 99.5%), and preservative (Phenonip® XB, available from Clariant International Ltd) were added to a mixing vessel and mixed for about 10 minutes. The colorant (FD&C Powder Series, Sensient Technologies®, Milwaukee, Wis.) was added, along with the binder (carboxymethyl hydroxypropyl guar (CMHPG), available from Economy Polymers & Chemicals, Houston, Tex.). The resulting solution was mixed for about five minutes, and then heated to a temperature of about 115° F. Once heated, the temperature was maintained and the mixing continued for an additional about five minutes. In a second mixing vessel, the sodium phosphate (Spectrum® Chemicals & Laboratory Products), sodium carbonate (Spectrum® Chemicals & Laboratory Products), sodium tetraborate (Spectrum® Chemicals & Laboratory Products), and the remaining water was combined, with the resulting mixture being heated to a temperature of about 170° F. to form a crosslinking solution. The crosslinking solution as added to the solution containing CMHPG, and the resulting mixture was stirred until a viscous gel composition was formed.

The resulting gel composition possessed a measured specific gravity (measured with a GARDCO device) of approximately 1.1 (at 24° C.); a measured density (at 24° C.) of approximately 1.1 g/cm³; a measured pH (at 24° C.) of approximately 8.34; and a measured viscosity (measure at 49° C. with a Brookfield Model FV-II Viscometer) of approximately 720 cP.

### EXAMPLE 2

TABLE 2

| Ingredient | Approximate Weight % |
|---|---|
| Deionized Water | 93.34 |
| Binder | 1.25 |
| Crosslinking System | |
| Sodium Phosphate (dibasic) | 0.60 |
| Sodium Sulfate | 0.80 |
| Sodium Carbonate (anhydrous) | 0.25 |
| Zirconium Lactate | 1.2 |
| Additives (humectant, preservative, colorant, | 2.56 |
| triethanolamine and sodium hydroxide) | |

About 95% of the deionized water and binder (carboxymethyl hydroxypropyl guar, TIGUAR® 418, available from Solvay North America, New Jersey) were added to a mixing vessel and mixed at a temperature of up to about 120° F. to dissolved the binder within the water. The mixture is then cooled to about 80° F., and humectant (glycerin 99.95%) and preservative (Phenostat™, available from Inolex Chemical Company) were added with further mixing in the vessel for about 10 minutes. The colorant (FD&C Powder Series, Sensient Technologies®, Milwaukee, Wis.) was then added with triethanolamine with further mixing for about 5 minutes. Sodium hydroxide was then added to adjust the pH to about 9.

In a second mixing vessel, the remaining 5% of deionized water was combined with sodium phosphate (Spectrum® Chemicals & Laboratory Products), sodium carbonate (Spectrum® Chemicals & Laboratory Products), and sodium sulfate (Spectrum® Chemicals & Laboratory Products), the resulting mixture being heated (e.g., to a temperature of about 170° F.) until the solid components dissolved. Upon complete dissolution, the contents of the second mixing vessel were added to the first mixing vessel. The resultant contents in the first mixing vessel were mixed while adding the zirconium lactate. Mixing continues until a homogenous gel was formed.

The resulting gel composition possessed a measured density (at 24° C.) of approximately 1.1 g/cm³ and a measured pH (at 24° C.) of approximately 9.2.

### EXAMPLE 3

TABLE 3

| Ingredient | Approximate Weight % |
|---|---|
| Deionized Water | 90.34 |
| Binder | 1.25 |
| Crosslinking System | |
| Sodium Phosphate (dibasic) | 0.60 |
| Sodium Sulfate | 0.80 |
| Sodium Carbonate (anhydrous) | 0.25 |
| Zirconium Lactate | 1.2 |
| Zinc Sulfide Copper | 3.0 |
| Additives (humectant, preservative, colorant, | 2.56 |
| triethanolamine and sodium hydroxide) | |

About 95% of the deionized water and binder (carboxymethyl hydroxypropyl guar, TIGUAR® 418, available from Solvay North America, New Jersey) were added to a mixing vessel and mixed at a temperature of up to about 120° F. to dissolved the binder within the water. The mixture is then cooled to about 80° F., and humectant (glycerin 99.95%) and preservative (Phenostat™, available from Inolex Chemical Company) were added with further mixing in the vessel for about 10 minutes. The colorant (FD&C Powder Series, Sensient Technologies®, Milwaukee, Wis.) and zinc sulfide copper (Phosphorescent Pigment 6SSU available from United Mineral and Chemical Corporation, New Jersey) were then added with triethanolamine with further mixing for about 5 minutes. Sodium hydroxide was then added to adjust the pH to about 9.

In a second mixing vessel, the remaining 5% of deionized water was combined with sodium phosphate (Spectrum® Chemicals & Laboratory Products), sodium carbonate (Spectrum® Chemicals & Laboratory Products), and sodium sulfate (Spectrum® Chemicals & Laboratory Products), the resulting mixture being heated (e.g., to a temperature of about 170° F.) until the solid components dissolved. Upon complete dissolution, the contents of the second mixing vessel were added to the first mixing vessel. The resultant contents in the first mixing vessel were mixed while adding the zirconium lactate. Mixing continues until a homogenous gel was formed.

The resulting gel composition possessed a measured density (at 24° C.) of approximately 1.1 g/cm³ and a measured pH (at 24° C.) of approximately 9.2.

Each of the above described formulations provides a playable, cohesive, nontoxic gel composition which has a stretchable, slimy consistency and tactile feel characteristic. The gel has a healable property so that if pulled apart, upon manipulation it will re-adhere to itself. It is believed that the crosslinking system of the present invention generates bonds that, while strong, are dynamic, such that they are constantly forming and dissociating, with the crosslinks moving randomly among the binder molecules. The result is that over short intervals, the strength of the crosslinks gives the gel composition its resilience, but over longer periods, the dynamic nature of the crosslinks allows the binder molecules to move relative to each other to provide the composition with its consistency.

One property of the gel composition of the present invention is a rheology which allows the composition to be formed into molded shapes, as well as to be integrally free flowing between fingers or down inclines. Another property of the gel is its cohesive nature which allows it to be stretched into long strands or stretched into thin membranes without breaking. A still further property of the instant play gel is its unexpected ability to conduct electricity, indicating an ionic mobility characteristic of the gel. The resulting integral mass behaves much like a free flowing amorphous “blob” which easily tears, packs, and recombines and will blanket or coat any surface to which is applied. The play gel material is malleable, pliable, free flowing; has a satisfactory tactile feel; can be used for long periods of time without drying to the point that it becomes unusable; would not be harmful if accidentally ingested; and exhibits a bright, shiny colorful appearance with no unpleasant odor. The play material can be simply cleaned-up and removed from carpets and fabrics with water.

The crosslinking system of the present invention may further be utilized in forming a moldable play composition or dough having soil-like characteristics. In an embodiment of the present invention, the dough composition includes particulate filler, a polymer binder, a thickener, a solvent, and the crosslinking system. The particulate filler may possess any suitable size and shape. In an embodiment of the present invention, the particulate filler possesses a particle size of less than about 100 μm and, in particular, of about 8 μm to 60 μm. The particulate filler includes, but is not limited to silica, granular material such as sand, and polymer microspheres such as Expancel® DE microspheres (available from AzkoNobel®, Sweden). In an embodiment, the particulate filler constitutes the largest component of the dough composition (measured by weight percent). In one embodiment of the present invention (e.g., when sand is utilized as the filler), the particulate filler may be present within the dough composition in an amount of about 30 wt % to about 50 wt % (e.g., about 40% by weight of the dough composition). In another embodiment (e.g., when polymer microspheres are utilized as the filler), the particulate filler may be present within the dough composition in an amount of about 3 wt % to about 45 wt %.

The binder includes crosslinkable polymers including vinyl acetate resins such as polyvinyl alcohol, polyacrylic acid, and combinations thereof. In an embodiment of the present invention, the polymeric binder may be fully or partially hydrolyzed polyvinyl alcohol. By way of example, the polyvinyl alcohol is a partially hydrolyzed polyvinyl alcohol having a degree of hydrolysis of 80 to 95 mol % (e.g., CELVOL 205 (88% hydrolyzed), available from Sekisu Specialty Chemicals, Dallas, Tex.). The polymeric binder may be present within the dough composition in an amount of about 4 wt % to about 15 wt % and, in particular, in an amount of about 5.50 wt % to about 11.50 wt %. By way of example, the amount of polymeric binder is about 8.50% by weight of the dough composition. In an embodiment of the present invention, the binder material is polyvinyl pyrrolidine, polyvinyl acetate, and mixtures thereof.

The thickener increases the viscosity of the dough composition, providing body, increasing stability, and improving suspension of ingredients. In an embodiment of the present invention, the thickener includes water-soluble polymers such as polysaccharides. By way of example, the thickener includes methyl cellulose, hydroxymethylcellulose, hydroxyethylcellulose, guar gum, and modified versions of the aforementioned such as guar gum derivatives (e.g., carboxymethyl hydroxypropyl guar). The thickener may be present within the dough composition in an amount of about 0.30 wt % to about 1.50 wt %. By way of example, the amount of thickener is about 0.70% by weight of the dough composition.

The crosslinking system of the present invention includes a combination of agents present in an amount effective to achieve formation of the polymer network. In an embodiment of the present invention, the crosslinking system is present in the dough composition in an amount of about 0.45 wt % to about 5.0 wt %. By way of example, the amount of cros slinking system is about 1.0% by weight of the dough composition. In an embodiment of the present invention, the primary crosslinking agent is present in an amount of about 0.50 wt % to about 3 wt %, the secondary crosslinking agent present in an amount of about 0.10 wt % to about 0.80 wt %, and the tertiary crosslinking agent is present in an amount of about 0.005 wt % to about 4.0 wt % or greater. In one example, the primary crosslinking agent is present in an amount of about 1% by weight of the dough composition, the secondary crosslinking agent present in an amount of about 0.15% by weight of the dough composition, and the tertiary crosslinking agent is present in an amount of about 0.09% by weight of the dough composition.

In an embodiment of the present invention, the primary crosslinking agent is potassium bicarbonate, the secondary crosslinking agent is sodium carbonate, and the tertiary crosslinking agent is sodium tetraborate. The amount of borate compound utilized in the dough composition is preferably less than about 0.50% by weight, and more preferably less than about 0.10% by weight.

In an embodiment of the present invention, the dough composition further includes a plasticizer to increase the plasticity of the composition. By way of example, the plasticizer includes diols such as ethylene glycol, propylene glycol, polyethylene glycol, polypropylene glycol, and combinations thereof. By way of specific example, the plasticizer is propylene glycol. The plasticizer may be present within the dough composition in an amount of about 2 wt % to about 10 wt % and, in particular, in an amount of about 3 wt % to about 7 wt %. By way of example, the amount of plasticizer is about 5% by weight of the dough composition.

In an embodiment of the present invention, the dough composition further includes a humectant to inhibit drying of the composition (by absorbing/adsorbing water). By way of example, the humectant is a polyol such as glycerin. The glycerin may present within the dough composition in an amount of about 0.50 wt % to about 8 wt % and, in particular, about 1 wt % to about 5 wt %. By way of example, the amount of humectant is about 3% by weight of the dough composition.

Water is generally used as the solvent. Tap water may be utilized; however, deionized water is preferred to minimize the potential for impurities that could interfere with crosslinking. In an embodiment of the present invention, water is present within the dough composition in an amount of about 25 wt % to about 75 wt %. By way of example, the amount of water present is about 35% by weight of the dough composition.

In an embodiment of the present invention, the dough composition includes various additives. For example, the composition may include an opacifying agent such as an acrylate emulsion (e.g., a styrene/acrylic emulsion (Acusol® OP301, available from Dow®)). The opacifying agent may be present within the dough composition in an amount of about 1 wt % to about 4 wt % (e.g., about 2 wt %). In addition, the dough composition of the present invention may include an antifoaming agent such as a silicone emulsion (e.g., Antifoam FG-10, available from Dow Coming®) present in an amount of about 0.10 wt % to about 1 wt % (e.g., 0.30 wt %).

Releasing agents can also be added to the dough composition of the present invention to reduce tackiness. Typical releasing agents include mineral oil, petroleum, and silicon wax (e.g., Xiameter® 200 polydimethylsiloxane, available from Dow Corning®) present in the composition in an amount of about 0.50 wt % to about 3 wt % (e.g., about 2 wt %). A preservative can be added to the dough composition of the present invention to increase shelf life, and a wide variety of preservatives are available. By way of example, preservatives include, but are not limited to, phenoxyethanol, methylparaben, ethylparaben, butlyparaben, propylparaben, isobutylparaben and combinations of two or more of the above. By way of specific example, the composition may include about 1 wt % Phenonip® XB (a preservative blend available from Clariant International AG, Muttenz, Switzerland). Many other commercially available preservatives well known to those skilled in the art may be used. In an embodiment of the present invention, the preservative is present within the dough composition in an amount of about 0.50 wt % to about 1.50 wt %.

The dough composition of the present invention may further include a colorant (e.g., a pigment or dye) to enhance its entertainment or play effect. Typical colorants include FD&C Powder Series or Iron Oxide Series colorants (available from Sensient Technologies Corporation, Milwaukee, Wis.), as well as the DayGlo® T-Series colorants (available from DayGlo Color Corporation, Cleveland, Ohio). The colorant may be present in an amount of about 0.50 wt % to about 2.50 wt %. By way of example, the amount of colorant is about 1% by weight of the dough composition. The dough composition of the present invention may further include a softening oil such as petroleum oil (e.g., a white mineral oil such as Drakeol® 9, available from Calumet Specialty Products Partners) present in an amount of about 1 wt % to about 3 wt % (e.g., about 2 wt %).

A formulation for a moldable dough composition in accordance with an embodiment of the present invention is provided in the example below with reference made to Table 4.

### EXAMPLE 4

TABLE 4

| Ingredient | Approximate Weight % |
|---|---|
| Deionized Water | 34 |
| Particulate Filler | 40 |
| Binder | 8 |
| Plasticizer | 5 |
| Humectant | 3 |
| Opacifying Agent | 2 |
| Mineral Oil | 2 |
| Crosslinking System | |
| Potassium Bicarbonate | 1 |
| Sodium Carbonate (anhydrous) | 0.15 |
| Sodium Tetraborate (anhydrous) | 0.10 |
| Misc (preservatives, colorant, | 5 |
| antifoaming agent, release agent, | |
| thickener) | |

Initially, a binder formulation is created. About 25 wt % deionized water at room temperature was added to a first vessel in the form of a jacketed mixing tank fitted with a mixer, a sweep, a turbine, and a homogenizer. The binder (Celvol® 205 Polyvinyl Alcohol, 88% hydrolyzed, available from Sekisui Specialty Chemicals, LLC, Dallas, Tex.) is added and mixed for about 10 minutes. The resulting solution is heated to a temperature of about 88° C.-93° C. The homogenizer is deactivated, and mixing continues for about 2-3 hours at the elevated temperature.

The now homogenous solution is cooled to room temperature. The plasticizer (propylene glycol, Spectrum® Chemicals & Laboratory Products), the humectant (glycerin 99.5%, Spectrum® Chemicals & Laboratory Products), and the thickener (hydroxyethylcellulose, Natrosol® 250 HH CS, Ashland Chemical Aqualon Division, Wilmington, Del.) are added, and mixing is continued for about 15 minutes. The colorant (Iron Oxide Series pigment, Sensient Technologies®, Milwaukee, Wis.) is added, and mixing is continued about 5 minutes. The preservative (Phenonip® XB, available from Clariant International Ltd) is then added and mixing continued for about 20 minutes.

In a second mixing vessel, a crosslinking system formulation is created. Specifically, the potassium bicarbonate (Spectrum® Chemicals & Laboratory Products), sodium carbonate (Spectrum® Chemicals & Laboratory Products), sodium tetraborate (Spectrum® Chemicals & Laboratory Products), and the remaining water is combined, and then mixed until dissolved.

In a third mixing vessel (e.g., a Hobart mixing bowl), the particulate filler (silica sand, available from Sand Art), the mineral oil (Drakeol® 9, available from Calumet Specialty Products partners, LP), and any other fillers are combined. The binder solution from the first mixing vessel is added and mixed until dispersed (about 15 minutes). Finally, the crosslinking solution from the second mixing vessel is added, and the combined mixtures are mixed until the desired material is formed.

The resulting composition is a modeling dough material that is kneadable, moldable, pliant and ductile enough to avoid tearing during use; that can be used for long periods of time without drying to the point that it becomes unusable; that is not harmful if accidentally ingested; and that exhibits a pleasant tactile feel with no unpleasant odor. The dough composition of the present invention possesses a unique combination of properties, including both a high degree of stretchability and a high degree of pliability when stress is applied. It does not flow appreciably under a rapid blow, but will flow readily under the application of a low, steady pressure. Other properties include excellent stability throughout a very wide temperature range.

While the present inventions have been described in detail and with reference to specific embodiments thereof, it will be apparent to one skilled in the art that various changes and modifications can be made therein without departing from the spirit and scope thereof. Weight percent refers to the amount of a component within the finished composition, unless otherwise noted. While the process for forming the compositions includes preferred steps, as well as preferred time and temperature parameters, it should be understood that the play compositions may be formulation utilizing other process steps, other temperatures, and other mixing times. Thus, it is intended that the present invention covers the modifications and variations of these inventions provided they come within the scope of the appended claims and their equivalents. Terms such as “first,” “second,” “third,”, “primary”, “secondary”, “tertiary”, etc., merely identify one of a number of portions, components and/or points of reference as disclosed herein, and do not limit the present inventions to any particular compositions, configurations, orientations or any implied meaning other than to signify different portions or components. Although the disclosed inventions are illustrated and described herein as embodied in one or more specific examples, it is nevertheless not intended to be limited to the details shown, since various modifications and structural changes may be made therein without departing from the scope of the inventions. In addition, various features from one of the embodiments may be incorporated into another of the embodiments. Accordingly, it is appropriate that the inventions be construed broadly and in a manner consistent with the scope of the disclosure.

Having described preferred embodiments, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A flowable play gel composition comprising:
water;
a binder; and
a crosslinking system to crosslink the binder, the crosslinking system comprising:
a primary crosslinking agent comprising a first alkali metal salt, wherein the primary crosslinking agent generates a first crosslink density in the binder;
a secondary crosslinking agent comprising a second alkali metal salt, wherein the secondary crosslinking agent generates a second crosslink density in the binder; and
a tertiary crosslinking agent comprising at least one of a zirconium compound and a titanium compound, wherein the third crosslinking agent generates a third crosslink density in the binder;
wherein the crosslinking system and the binder cooperate to form a hydrogel including a polymer network expanded throughout its volume by the water.

2. The flowable play gel composition of claim 1, wherein the binder is guar gum.

3. The flowable play gel composition of claim 2, wherein the tertiary crosslinking agent comprises a zirconium compound present in an amount of about 4.0% or less by weight gel composition.

4. The flowable play gel composition of claim 3, wherein the zirconium compound comprises zirconium lactate.

5. The flowable play gel composition of claim 2, wherein:
the primary crosslinking agent comprises a phosphoric acid salt; and
the secondary crosslinking agent comprises a carbonic acid salt.

6. The flowable play gel composition of claim 5, wherein the secondary crosslinking agent further comprises a sulfonic acid salt.

7. The flowable play gel composition of claim 6, wherein:
the primary crosslinking agent comprises disodium hydrogen phosphate; and
the secondary crosslinking agent comprises sodium carbonate and sodium sulfate.

8. The flowable play gel composition of claim 7, wherein the tertiary crosslinking agent comprises zirconium lactate.

9. The flowable play gel composition of claim 8, wherein:
the guar gum comprises carboxylmethyl hydroxypropyl guar.

10. The flowable play gel composition of claim 2, wherein:
the water is present in a range of about 75% to about 95% by weight gel composition;
the guar gum binder is present in a range of about 0.50% to about 3% by weight gel composition; and
the crosslinking system is present in a range of about 0.10% to about 5.0 wt % by weight gel composition.

11. The flowable play gel composition of claim 1, further comprising at least one colorant additive.

12. The flowable play gel composition of claim 11, wherein the at least one colorant additive comprises a phosphorescent compound.

13. The flowable play gel composition of claim 12, wherein the phosphorescent compound comprises zinc sulfide copper.

14. The flowable play gel composition of claim 2, further comprising a humectant.

15. The flowable play gel composition of claim 14, wherein the humectant comprises glycerin.

16. A moldable dough composition comprising:
water;
a binder;
a crosslinking system to crosslink the binder, the crosslinking system comprising:
a primary crosslinking agent comprising a first alkali metal salt, wherein the primary crosslinking agent generates a first crosslink density in the binder;
a secondary crosslinking agent comprising a second alkali metal salt, wherein the secondary crosslinking agent generates a second crosslink density in the binder; and
a tertiary crosslinking agent comprising at least one of a zirconium compound and a titanium compound, wherein the third crosslinking agent generates a third crosslink density in the binder; and
a particulate filler.

17. The moldable dough composition of claim 16, wherein:
the binder comprises polyvinyl alcohol; and
the dough composition further comprises a diol compound.

18. The moldable dough composition of claim 16, wherein the particulate filler is present in a range of about 30% to about 50% by weight of the dough composition.

19. The moldable dough composition of claim 16, wherein the particulate filler comprises at least one of silica particles and polymer microspheres having sizes less than about 100 μm.

20. The moldable dough composition of claim 16, further comprising a thickener to increase the viscosity of the dough composition in relation to the dough composition without the thickener.

21. A crosslinking system to crosslink a polymeric binder within a play composition, the crosslinking system comprising:
a primary crosslinking agent comprising at least one of an alkali metal bicarbonate and a salt of a phosphoric acid, wherein the primary crosslinking agent generates a first crosslink density in the binder;
a secondary crosslinking agent comprising at least one of an alkali metal carbonate and an alkali metal sulfate, wherein the secondary crosslinking agent generates a second crosslink density in the binder; and
a tertiary crosslinking agent comprising at least one of a zirconium compound and a titanium compound, wherein the tertiary crosslinking agent generates a third crosslink density in the binder;
wherein the crosslinking system crosslinks the polymeric binder forming the play composition.
